(19) United States
(12) Patent Application Publication
(10) Pub. No.: US 2002/0149999 A1
(43) Pub. Date: Oct. 17, 2002

(54) Timekeeper mouse

(76) Inventor: Jessica Chang, Taipei (TW)

Correspondence Address: RABIN & CHAMPAGNE, PC, 1101 14TH STREET, NW, SUITE 500, WASHINGTON, DC, 20005, US

(21) Appl. No.: 09/892,739

(22) Filed: Jun. 28, 2001

(30) Foreign Application Priority Data
Apr. 11, 2001 (TW) 90205641

(51) Int. Cl. G04B 47/00

(52) U.S. Cl. 368/10

(57) ABSTRACT

The present invention provides a timekeeper mouse comprising a mouse and a timekeeper. A receiving space is concavely formed on the mouse so that the timekeeper can be exactly disposed thereon. The timekeeper has a display unit and an alarm unit (e.g., a voice part or a light emitting part) connected with a control circuit. The timekeeper has keys thereon for starting timekeeping, setting time, and resetting time. The keys are connected with the control circuit. When a computer is not in use, a user of the mouse can set use time on the timekeeper. When the computer is turned on for use, the timekeeping key can be pressed to start timekeeping. Once the set time is arrived, the control circuit will drive the voice part to give out sound or drive the light emitting part to give out light, hence informing the use the time of operating the computer.

### FIELD OF THE INVENTION

The present invention relates to a timekeeper mouse and, more particularly, to device capable of informing a user the time of operating a computer.

### BACKGROUND OF THE INVENTION

A mouse is a peripheral input unit of computer. A mouse can control the movement and scroll of a frame on a computer screen, and is a prerequisite equipment of a general computer user. In other words, the use of a mouse is very frequent so that a computer user usually does not know the use time of mouse.

There are program icons having time function to be directly selected on a computer screen. However, they cannot let the parents know the use time of their children on a computer.

Accordingly, the present invention aims to propose a timekeeping device capable of directly informing a user the time of operating a computer.

### SUMMARY OF THE INVENTION

One object of the present invention is to provide a device capable of informing a user the time of operating a computer, wherein a receiving space is concavely formed on a mouse so that a timekeeper can be exactly disposed thereon. The timekeeper has a display unit and an alarm unit (e.g., a voice part or a light emitting part) connected with a control circuit therein. The timekeeper has keys thereon for starting timekeeping, setting time, and resetting time. The keys are connected with the control circuit. A user can thus be informed of the time of operating a computer.

Another object of the present invention is to provide a device capable of letting the parents monitor their children the time of using a computer.

The various objects and advantages of the present invention will be more readily understood from the following detailed description when read in conjunction with the appended drawing, in which:

### BRIEF DESCRIPTION OF THE DRAWINGS

FIG. 1 is an exploded perspective view of the present invention;

FIG. 2 is a perspective view of the present invention; and

FIG. 3 is a perspective view according to another embodiment of the present invention.

### DETAILED DESCRIPTION OF THE PREFERRED EMBODIMENTS

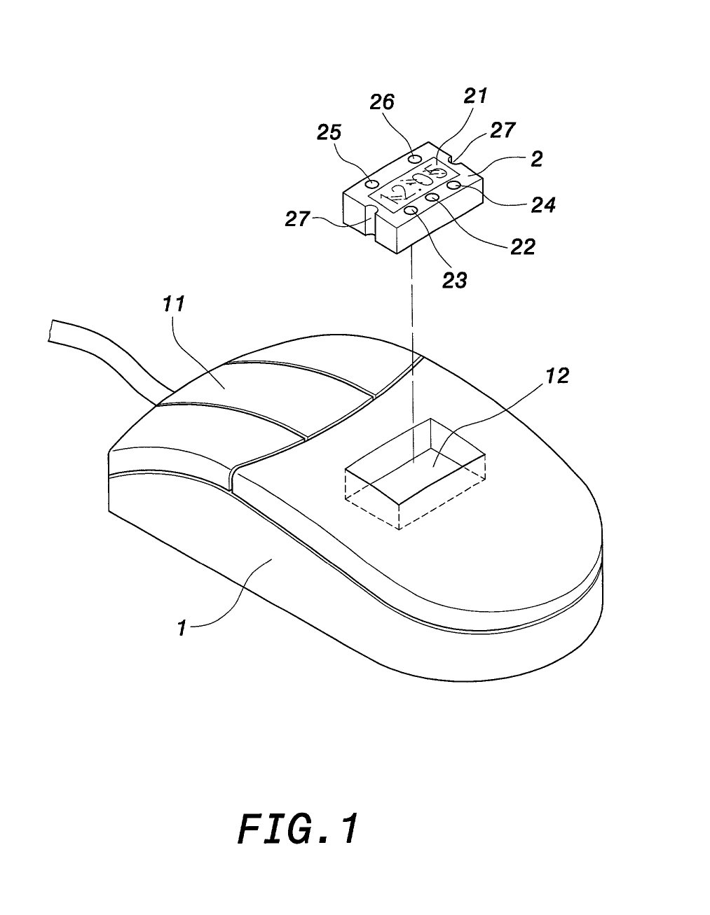

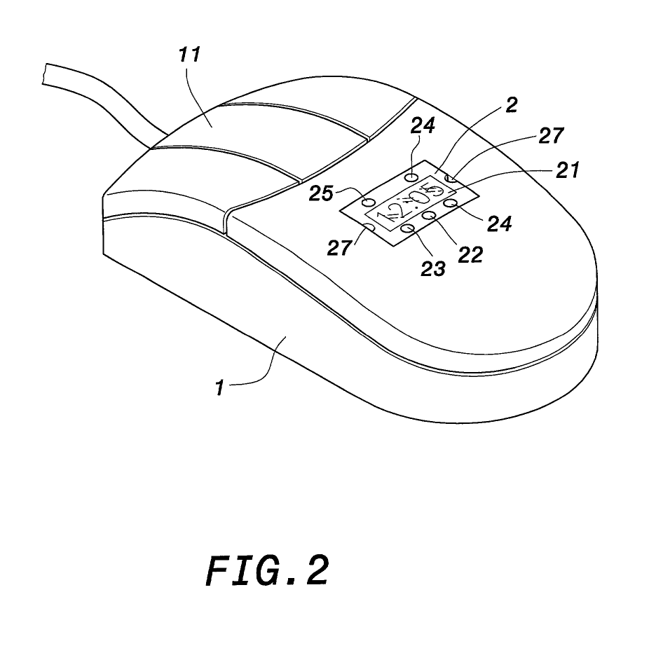

As shown in FIGS. 1 and 2, a timekeeper mouse of the present invention comprises a mouse 1 and a timekeeper 2.

The mouse 1 has a plurality of maneuvering keys 11 thereon. A rectangular receiving space 12 is concavely formed at a portion thereof adjacent to the plurality of maneuvering keys 11. The size of the receiving space 12 lets the timekeeper 2 be exactly disposed thereon.

The timekeeper 2 has a display unit 21 thereon. In this embodiment of the present invention, the display unit 21 is a liquid crystal display (LCD). Keys 22 for starting timekeeping, setting time, and resetting time are disposed at one side of the timekeeper 2 adjacent to the display unit 21. The keys 22 are connected with an internal control circuit (not shown) of the timekeeper 2. The timekeeper 2 has a voice part 25 and a light emitting part 26 both connected with the control circuit. The voice part 25 or the light emitting part 26 gives out voice or light to inform a computer user when the set time is arrived. A guide hole 27 is concavely formed at each side of the timekeeper 2 so that the timekeeper 2 can be taken out for replacement of battery and then assembled into the receiving space 12 when the timekeeper 2 runs out of electrical power.

When a computer is not in use, a user of the mouse can set use time on the timekeeper 2. When the computer is turned on for use, the timekeeping key 22 can be pressed to start timekeeping. Once the set time is arrived, the control circuit will drive the voice part 25 to give out sound or drive the light emitting part 26 to give out light, hence informing the use time of operating the computer.

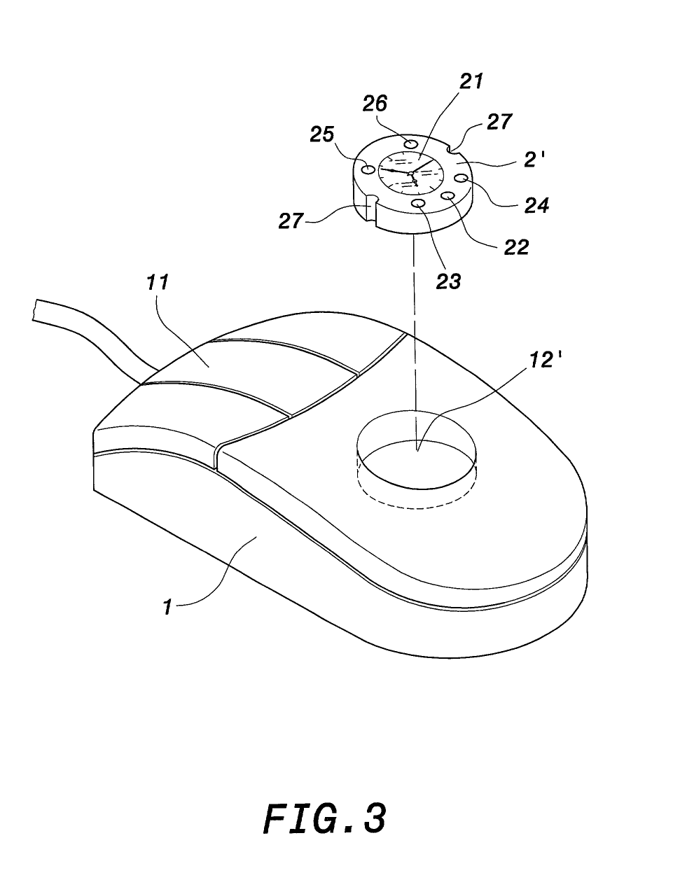

As shown in FIG. 3, a receiving space 12′ of the mouse 1 can be varied according to the shape of a timekeeper 2′. A display unit 21′ can also be a pointer type driving unit.

To sum up, the present invention can inform a user (e.g., a computer engineer) the time of operating a computer, and can let the parents monitor their children the time of using a computer.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A timekeeper mouse comprising:
a mouse having a receiving space concavely formed thereon; and
a timekeeper disposed on said receiving space, said timekeeper having a display unit and an alarm unit thereon both connected with a control circuit,
keys for starting timekeeping, setting time, and resetting time being disposed on said timekeeper and connected with said control circuit;
whereby a user can be informed of the time of operating a computer.

2. The timekeeper mouse as claimed in claim 1, wherein the shape of said timekeeper can be designed according to a surface of said mouse.

3. The timekeeper mouse as claimed in claim 1, wherein said display unit can be a liquid crystal display.

4. The timekeeper mouse as claimed in claim 1, wherein said display unit can be a pointer type driving unit.

5. The timekeeper mouse as claimed in claim 1, wherein said alarm unit can be a voice part or a light emitting part.
